(19) United States
(12) Patent Application Publication
(10) Pub. No.: US 2006/0152567 A1
(43) Pub. Date: Jul. 13, 2006

(54) Feeding device and recording device

(76) Inventors: Satoshi Fujioka, Nagano-ken (JP); Yasuyuki Sakato, Nagano-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 10/546,516

(22) PCT Filed: Apr. 30, 2004
(86) PCT No.: PCT/JP04/06364

§ 371 Date: Aug. 23, 2005

(30) Foreign Application Priority Data
May 1, 2003 (JP) 2003-126181
Apr. 28, 2004 (JP) 2004-132620

(51) Int. Cl. B41J 2/01

(52) U.S. Cl. 347/104

(57) ABSTRACT

A feeder includes a guide section 141d for guiding a medium while partially abutting one side of the medium in feeding the medium. Accordingly, the frictional resistance occurring between one side of the medium and the guide section can be lessened, so that a feed failure such as paper break or a paper jam can be prevented from occurring. Therefore, paper of various sizes can be reliably fed.

### TECHNICAL FIELD

This invention relates to a feeder for feeding a medium and a recording apparatus and a liquid ejection apparatus each including the feeder.

### BACKGROUND ART

An ink jet printer, one of large recording apparatus capable of printing on paper of A4 size of the JIS to a comparatively large size such as A2 size of the JIS, for example, as media, is available. With such a large ink jet printer, it is difficult to feed paper from the rear and eject paper to the front as in a small ink jet printer because of handling heavy paper and therefore paper is fed and ejected on the front. That is, a paper feed tray and a paper ejection tray are disposed on the front of the ink jet printer. Paper stored in the paper feed tray is taken out by a paper feed roller and is fed with both sides of the paper guided by edge guides.

The edge guide on one side of the paper is slidable in the width direction of the paper and is attached so that the slide load varies depending on the sliding direction of the edge guide. That is, when the edge guide is slid from the outside to the paper side and is abutted against the side of the paper, the slide load of the edge guide lessens to slide the edge guide smoothly. When paper is fed, the slide load of the edge guide grows so that the edge guide is not slid from the paper side to the outside even by the side pressure caused by the side of the paper. Accordingly, the paper can be reliably regulated by the edge guide, so that feeding the paper in a skew state can be prevented (refer to JP-A-9-86676).

The above-described ink jet printer in the related art can print on paper of a comparatively large size. However, if such paper is guided in a state in which both sides of the paper abut the whole portions of both edge guides, the frictional resistance occurring between both sides of the paper and both edge guides will become too large and it is feared that a feed failure such as paper break or a paper jam may occur.

It is an object of the invention to reliably feed paper of various sizes.

### DISCLOSURE OF THE INVENTION

To accomplish the above-described object, a feeder as claimed in claim 1 is a feeder for feeding a medium, characterized by a guide section for guiding the medium while partially abutting one side of the medium in feeding the medium. Accordingly, the frictional resistance occurring between one side of the medium and the guide section can be lessened, so that a feed failure such as paper break or a paper jam can be prevented from occurring.

The feeder as claimed in claim 2 is characterized in that the guide section is formed as a step in guide means attached slidably in a direction orthogonal to the feeding direction of the medium. Accordingly, the need for providing the guide section as a separate part is eliminated, so that the number of parts does not increase and the costs of parts manufacturing, assembling, etc., can be reduced.

The feeder as claimed in claim 3 is characterized in that the feeder includes supply means for supplying the stored media, separation means for separating only the top medium of the supplied media, and feeding means for feeding the separated medium and that the guide section is formed so that feed load occurring as the medium and the guide section come in contact with each other lessens when the medium is displaced in a gap between the separation means and the supply means with the progress of feeding of the feeding means after supply of the supply means is released. Accordingly, if the medium is brought away from the supply means and is fed only by the feeding means, the contact resistance between the medium and the guide section gradually lowers, so that degradation of the feeding accuracy of the medium by the feeding means and the guide section can be prevented.

Further, the feeder as claimed in claim 4 is characterized in that the guide section is formed so that the abutment portion against the medium gradually decreases with the progress of feeding the medium by the feeding means. Accordingly, the guide section can be easily made, so that the disposition space and the disposition cost can be minimized as necessary.

The feeder as claimed in claim 5 is characterized in that the separation means includes a rough surface for separating only the top medium. The feeder is characterized in that the separation means includes a roller for separating only the top medium. The feeder is characterized in that the separation means includes a claw for separating only the top medium. Accordingly, the feeder including various separation means is provided with the guide section and the feeding accuracy can be enhanced.

To accomplish the above-described object, a recording apparatus as claimed in claim 6 is a recording apparatus for recording on the medium and is characterized in that it includes each feeder described above. Accordingly, the recording apparatus for providing the various advantages described above can be provided.

To accomplish the above-described object, a liquid ejection apparatus as claimed in claim 7 is a liquid ejection apparatus for ejecting a liquid to a liquid-ejected medium and is characterized in that it includes each feeder described above. Accordingly, the liquid ejection apparatus for providing the various advantages described above can be provided.

### BRIEF DESCRIPTION OF THE DRAWINGS

FIG. 1 is a perspective view viewing the whole of the appearance of an ink jet printer, one of recording apparatus according to one embodiment of the invention, from the slanting front.

FIG. 2 is a perspective view of a paper feed and ejection tray of the printer in FIG. 1.

FIG. 3 is a perspective view to show a use mode of the paper feed and ejection tray in FIG. 2.

FIG. 4 is a perspective view to show another use mode of the paper feed and ejection tray in FIG. 2.

FIG. 5 is a sectional side view to show an outline of the internal configuration of the printer in FIG. 1.

FIG. 6 is a drawing to show a contact state between paper placed on a hopper and a paper feed roller.

FIG. 7 is a perspective view to show details of a paper feed and ejection section according to the embodiment of the invention.

FIG. 8 is a perspective view to show details of the main part of the paper feed and ejection section in FIG. 7.

FIG. 9 is a front view of the part in FIG. 8.

FIG. 10 is a side view of the part in FIG. 8.

FIG. 11 is a sectional view to show the internal structure of an ink jet printer including a separation member having a roller and enabling rear automatic paper feed.

FIG. 12 is a perspective view to show the periphery of a retard roller in FIG. 11.

FIG. 13 is a side view of FIG. 12.

FIG. 14 is a rear perspective view of FIG. 12.

FIG. 15 is a sectional view to show the internal structure of an ink jet printer including a separation member having a roller and enabling front automatic paper feed.

FIG. 16 is a sectional side view to show a paper feed cassette including separation members having claws.

FIG. 17 is a plan view of the paper feed cassette in FIG. 16.

FIG. 18 is an operation drawing of a separation mechanism when the paper feed cassette is placed in an ink jet printer.

FIG. 19 is a plan view of FIG. 18.

FIG. 20 is a plan view of the paper feed cassette placed in the ink jet printer.

FIG. 21 is a first drawing to show the paper transport state of the printer in FIG. 1.

FIG. 22 is a second drawing to show the paper transport state of the printer in FIG. 1.

### BEST MODE FOR CARRYING OUT THE INVENTION

An embodiment of the invention will be discussed in detail based on the accompanying drawings.

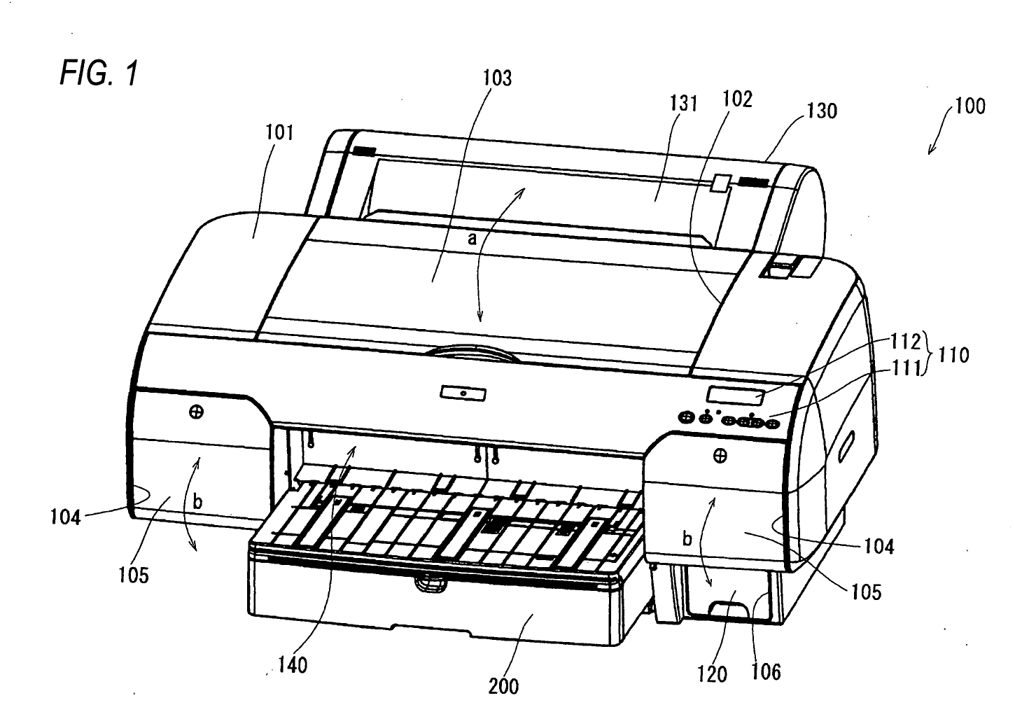

FIG. 1 is a perspective view viewing the whole of the appearance of an ink jet printer, one of recording apparatus according to one embodiment of the invention, from the slanting front. The ink jet printer 100 is a desktop large printer capable of printing on so-called cut paper of A4 size of the JIS to a comparatively large size such as A2 size of the JIS, for example, and roll paper, and is covered with a housing 101 roughly like a rectangular parallelepiped extending long in the width direction as a whole.

A rectangular window 102 is formed on the top of the housing 101. The window 102 is covered with a transparent or translucent window cover 103. The window cover 103 is attached so that it can rotate in an arrow a direction shown in the figure on an upper rotation shaft. The user can perform maintenance work of the internal mechanism, etc., through the window 102 by lifting the window cover 103 and opening the window 102.

A cartridge storage section 104 where a plurality of ink cartridges are inserted and extracted is formed on each side of the front of the housing 101. Each ink cartridge stores each color ink for print. Each cartridge storage section 104 is covered with a transparent or translucent cartridge cover 105. The cartridge cover 105 is attached so that it can rotate in an arrow b direction shown in the figure on a lower rotation shaft. The user can perform replacement work of the ink cartridge, etc., by lightly pressing the cartridge cover 105 to detach a hold part and opening the cartridge storage section 104.

An operation section 110 for giving a printer operation command is disposed on the top of the cartridge storage section 104 on the front right of the housing 101. The operation section 110 includes buttons 110 such as a power button for turning on/off power, operation buttons for locating the top of paper, etc., flushing of ink, etc., and processing button for performing image processing, etc, a liquid crystal panel 112 for displaying the state, and the like. The user can operate the buttons 111 while checking seeing the liquid crystal panel 112.

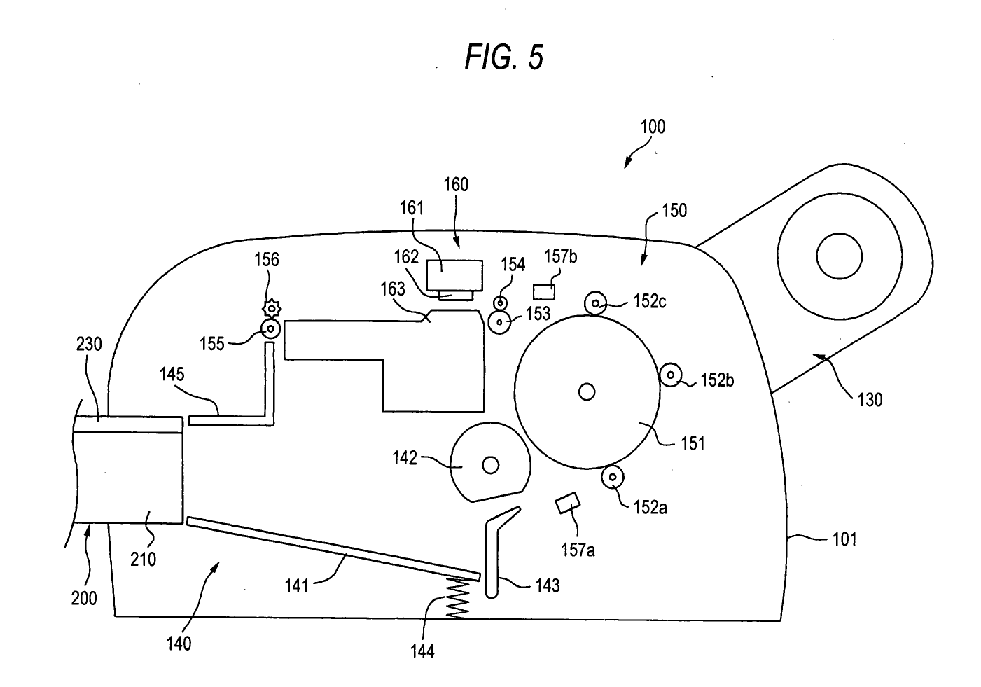

A tank storage section 106 where a waste liquid tank 120 is inserted and extracted is formed below the cartridge storage section 104 on the front right of the housing 101. The waste liquid tank 120 stores waste ink discarded at the cleaning treatment of a record head unit 162 (see FIG. 5) and at the ink cartridge replacing time. The user can perform discard work of waste ink accumulating in the waste liquid tank 120, etc., by drawing out the waste liquid tank 120.

A paper feed section 130 for feeding roll paper is disposed at the rear of the housing 101 so as to project upward backward. A roll paper holder not shown on which one roll of paper can be set is disposed in the paper feed section 130, and a flip-up roll paper cover 131 that can be opened and closed is attached so as to cover the roll paper holder not shown on the front of the paper feed section 130. The user can perform attachment/detachment work of roll paper, etc., by lifting the roll paper cover 131 and opening the paper feed section 130. The top face of the roll paper cover 131 is formed as a paper feed guide face for enabling manual paper feed guide of cut paper.

A paper feed and ejection section 140 where a paper feed and ejection tray 200 for stacking cut paper before print, cut paper after print, or roll paper is inserted and extracted is formed at the front center of the housing 101, namely, between the paired the cartridge storage sections 104. The paper feed and ejection section 140 is also formed so as to enable manual paper feed of thick paper that cannot be folded down at the transporting time.

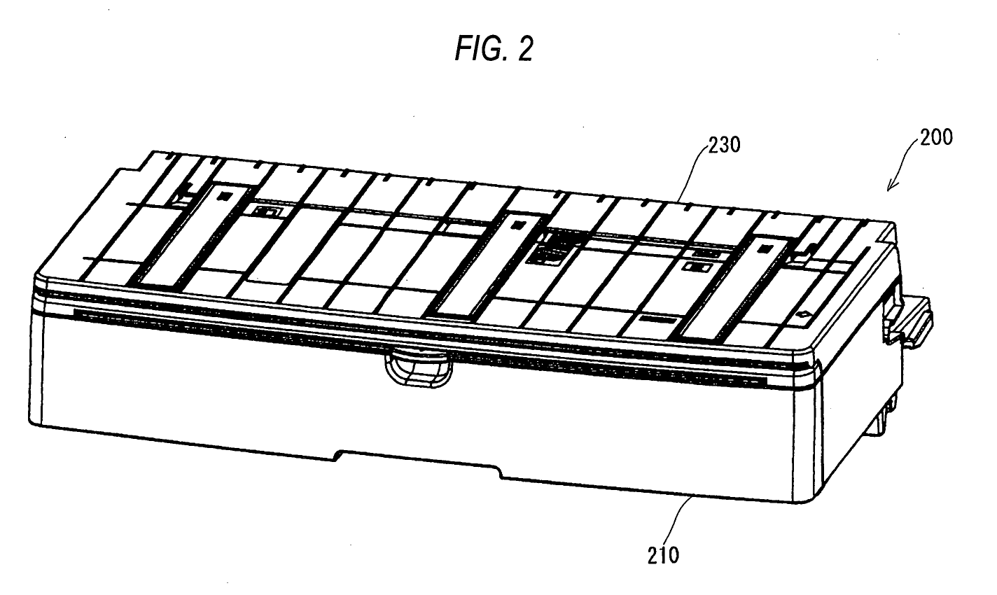

The front of the paper feed and ejection tray 200 is inserted into the paper feed and ejection section 140 and is fixed in such a manner that the back of the paper feed and ejection tray 200 projects. The paper feed and ejection tray 200 is formed like a cassette; cut paper fed before print is stacked inside for storage and cut paper ejected after print or roll paper is stacked in the upper part. The detailed structure of the paper feed and ejection tray 200 will be discussed with reference to FIGS. 2 to 4.

FIG. 2 is a perspective view viewing the whole of the appearance of the paper feed and ejection tray 200 from the slanting front. The paper feed and ejection tray 200 includes a paper feed tray 210 formed like a box and a paper ejection tray 230 formed like a lid covering the top face of the paper feed tray 210. The paper feed and ejection tray 200 is formed so that it can be expanded and contracted in paper feed and ejection directions; when the paper feed and ejection tray 200 is not used, it can be stored compactly and when it is used, it can deal with cut paper of various sizes.

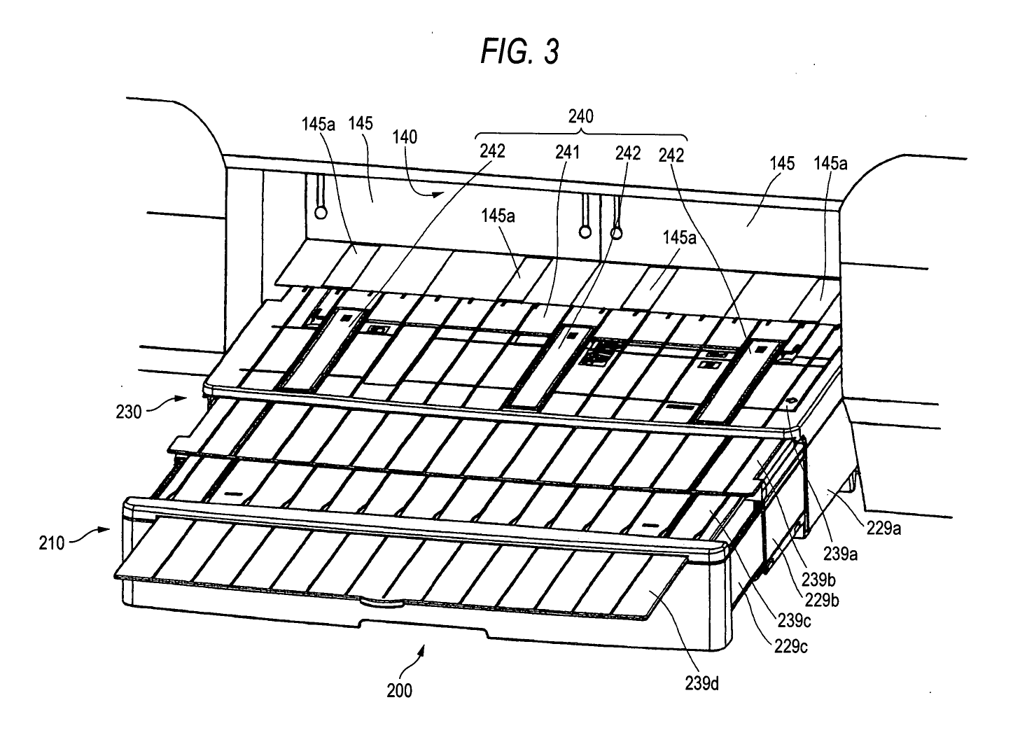

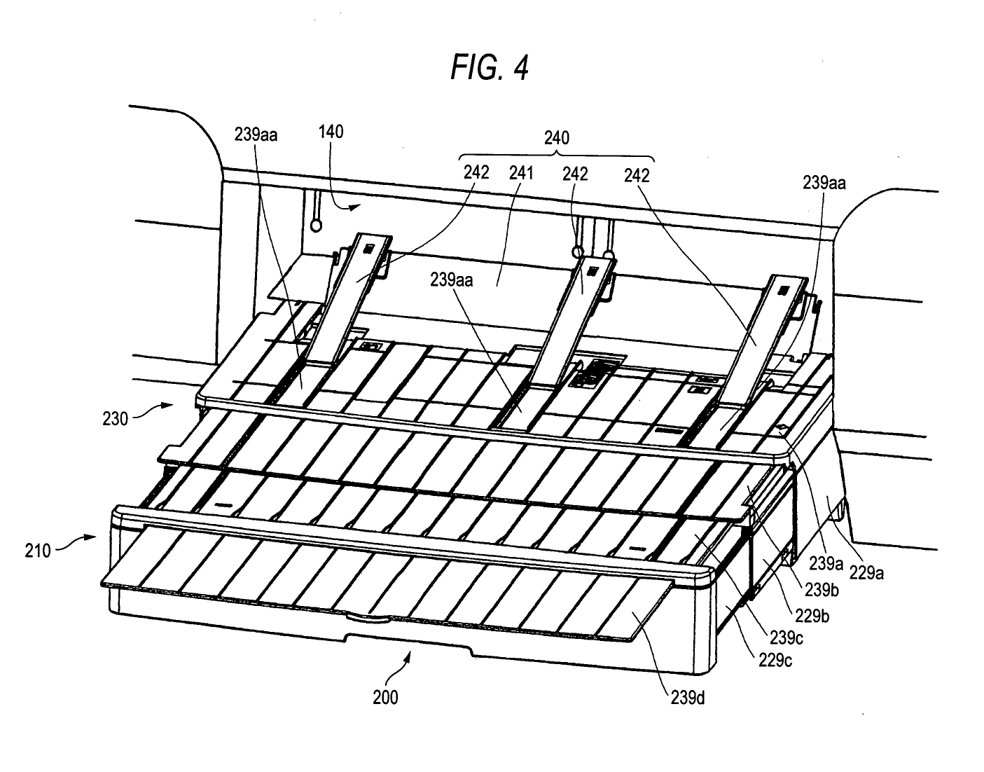

FIGS. 3 and 4 are perspective views to show the paper feed and ejection section 140 in which the paper feed and ejection tray 200 is placed. To stack cut paper, a roll paper guide section 240 is stored on the top face of a paper ejection member 239a, namely, the top face of the paper ejection member 239a is made a flat face, as shown in FIG. 3. Accordingly, cut paper ejected through a paper ejection roller 155 (see FIG. 5) is smoothly stacked on a paper ejection reception face formed by the side and the bottom of a guide section 145 formed like a letter L in cross section and the top faces of paper ejection members 239a to 239d.

A sponge mat 145a is put on the bottom of the guide section 145. After a first sheet of cut paper is placed, when a second sheet of cut paper is ejected, the sponge mat 145a has a non-slip function for preventing the leading end of the second sheet of cut paper from prompting the first sheet of cut paper and pushing the first sheet off the paper ejection reception face.

On the other hand, to stack roll paper, the user puts his or her finger on an opposite long side of a first guide plate 241 of the roll paper guide section 240 stored on the top face of the paper ejection member 239a and turns the first guide plate 241 toward the rear, as shown in FIG. 4. Then, a second guide plate 242 is pulled by the first guide plate 241, one end side in the length direction is lifted up, and an opposite end side in the length direction slides backward along a groove 239aa formed on the top face of the paper ejection member 239a. The user turns the first guide plate 241 until the angle formed between the first guide plate 241 and the second guide plate 242 becomes an acute angle.

Accordingly, the second guide plate 242 becomes like a slide with one end side in the length direction approaching the summit of the side of the guide section. Thus, if roll paper ejected through the paper ejection roller curls, the leading end is not caught in the guide section side and glides on the second guide plate 242 like a slide and is guided to the top face sides of the paper ejection members 239a to 239d. Therefore, the roll paper is smoothly stacked on the paper ejection reception face formed by the second guide plate 242 and the top faces of the paper ejection members 239a to 239d.

FIG. 5 is a sectional side view to show an outline of the internal configuration of the ink jet printer 100 in FIG. 1. The paper feed and ejection section 140, a transport section 150, a record section 160, and the like are disposed in the housing 101. A hopper 141 for feeding cut paper, a paper feed roller 142, a separation member 143, and the like are disposed in the paper feed and ejection section 140. The hopper 141 is formed like a flat on which cut paper can be placed and is disposed so that one end is positioned in the proximity of the paper feed roller 142 and the separation member 143 and that an opposite end is positioned in close vicinity to the bottom of the paper feed tray 210 of the placed paper feed and ejection tray 200. An opposite end of a compression spring 144 with one end attached to the bottom of the housing 101 is attached to the back of the hopper 141 on one end side thereof, and the one end side turns on the opposite end side as the compression spring 144 is expanded and contracted.

The paper feed roller 142 is formed like a letter D in cross section with a part broken away and intermittently rotates for frictionally transporting cut paper on the hopper 141. The separation member 143 has a top face formed as a rough surface and when multiple sheets of cut paper are transported by the paper feed roller 142, the separation member 143 frictionally separates the lower sheet of cut form from the top sheet of cut paper. Here, the relationship between cut paper placed on the hopper 141 and the paper feed roller 142 will be discussed with reference to drawings.

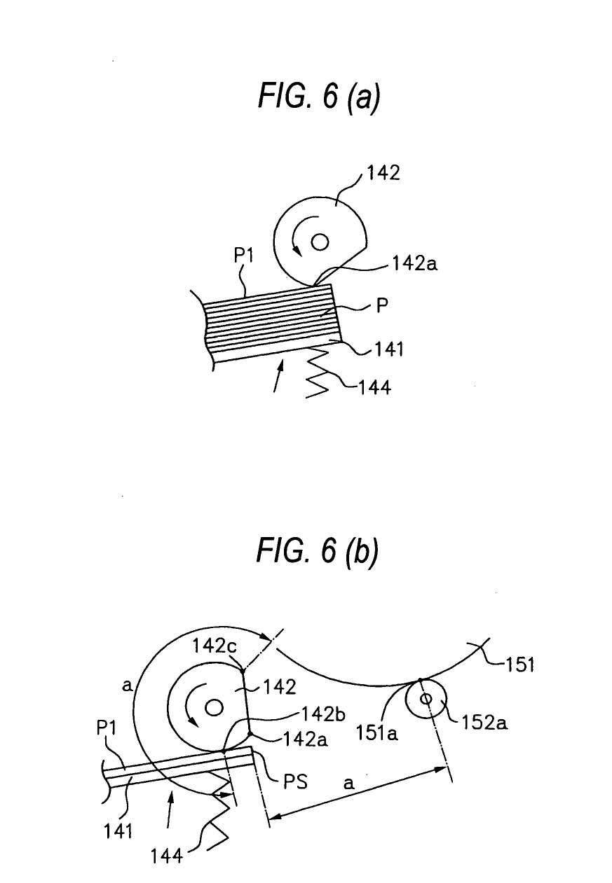

FIG. 6 is a drawing to show a contact state between cut paper placed on the hopper 141 and the paper feed roller 142. FIG. 6 (A) shows the case where a maximum number of sheets of cut paper P are placed on the hopper 141. In this case, adjustment is made so that when the hopper 141 moves up, the top sheet of cut paper P comes in contact with the circumference at least on and after a circular arc start point 142a without coming in contact with the broken-away part of the paper feed roller 142.

FIG. 6 (B) shows the case where a minimum number of sheets of cut paper P1 (one sheet) is placed on the hopper 141. In this case, adjustment is made so that when the hopper 141 moves up, the sheet of cut paper P1 comes in contact with a point 142b a little rotated from the circular arc start point 142a of the paper feed roller 142. The contact point 142b is a point when the circumference length from the contact point 142b to a circular arc end point 142c becomes same length a as the spacing from a leading end ps of the paper P1 to a contact point 115a between a subroller 151 and a driven roller 152a thereof.

As adjustment is thus made, if the number of sheets of cut paper P placed on the hopper 141 is equal to or less than the maximum number, the cut paper P1 is not released from the paper feed roller 142 until the leading end ps of the top sheet of cut paper P1 reaches the contact point 151a between the subroller 151 and the driven roller 152a thereof, so that the cut paper P1 can be reliably passed to the subroller 151 and a paper feed mistake can be eliminated.

Disposed in the transport section 150 are the subroller 151 and driven rollers 152a, 152b, and 152c thereof for transporting paper, a paper delivery roller 153 and a driven roller 154 thereof, a paper ejection roller 155, a serrated roller 156, detection sensors 157a and 157b for detecting paper, and the like. To eject cut paper fed from the paper feed tray 210 to the paper ejection tray 230, the subroller 151 inversely transports the cut paper like a letter U with the cut paper sandwiched between the subroller 151 and the driven roller 152a, 152b, 152c. To eject roll paper fed from the paper feed section 130 to the paper ejection tray 230, the subroller 151 transports the roll paper with the roll paper sandwiched between the subroller 151 and the driven roller 152c.

The paper delivery roller 153 delivers inversely transported cut paper or fed roll paper to a platen 163 with the paper sandwiched between the paper delivery roller 153 and the driven roller 154. The paper ejection roller 155 ejects paper passing through the platen 163 onto the paper ejection tray 230 with the paper sandwiched between the paper ejection roller 155 and the serrated roller 156. The detection sensor 157a detects the transport amount in skew removal of fed cut paper. The detection sensor 157b detects the transport amount in locating the top of inversely transported cut paper or transported roll paper.

A carriage 161, the record head unit 162, and the like are disposed in the record section 160. The carriage 161 is coupled with a carriage belt not shown and when the carriage belt is operated by a carriage drive not shown, the carriage 161 operates in conjunction with the motion of the carriage belt and reciprocates along a guide shaft not shown.

The record head unit 162 includes, for example, a plurality of black ink record heads for ejecting two types of black ink and a plurality of color ink record heads for ejecting ink of six colors of yellow, dark yellow, cyan, light cyan, magenta, and light magenta. The record head unit 162 is provided with pressure generation chambers and nozzle openings concatenated therewith and as ink is stored in the pressure generation chamber and is pressurized at a predetermined pressure, an ink droplet of a controlled size is ejected toward paper from the nozzle opening.

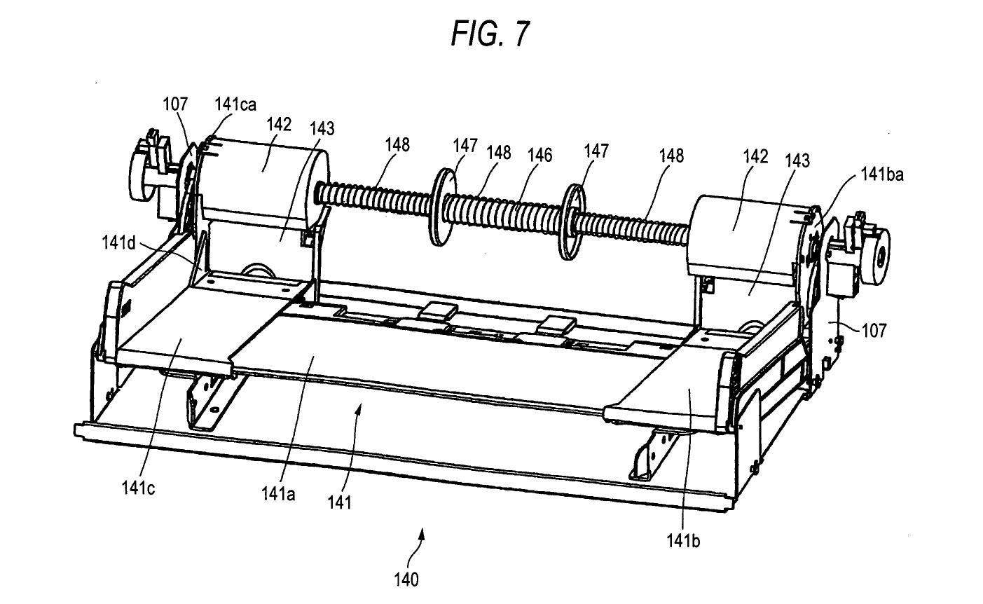

FIG. 7 is a perspective view to show the detailed structure of the above-described paper feed and ejection section 140 containing a characteristic portion of the invention. The hopper 141 includes a flat support plane 141a for supporting a face of cut paper and a right edge guide 141b and a left edge guide (guide means) 141c each like a letter L in cross section for guiding both sides of cut paper supported on the support plane 141a. The right edge guide 141b on the right viewed from the front is fixedly attached to the right side of the support plane 141a, and the left edge guide 141c on the left viewed from the front is attached slidably from the left side of the support plane 141a to the right side. As the left edge guide 141c is slid, paper of A4 size to A2 size of the JIS can be reliably supported and both sides of the paper can be guided precisely.

Further, the whole portion of a bend part of the right edge guide 141b abuts the right side of cut paper for guide, and an edge guide (guide section) 141d, a characteristic portion of the invention, formed as a step at the depth of a bend part of the left edge guide 141c abuts partially the left side of cut paper for guide. That is, the edge guide 141d has a function of bringing the left side of cut paper away from the bend part of the left edge guide 141c so as to prevent the left side of cut paper from abutting the whole portion of the bend part of the left edge guide 141c.

When cut paper is fed by the paper feed roller 142, if cut paper is guided in a state in which both sides of the cut paper abut the whole portions of the bend parts of both the edge guides 141b and 141c, the frictional resistance occurring between both sides of the cut paper and the bend parts of both the edge guides 141b and 141c will become too large and it is feared that a feed failure such as paper break or a paper jam may occur. However, the edge guide 141d is provided, whereby the cut paper is guided in a state in which the right side of the cut paper abuts the whole portion of the bend part of the edge guide 141b and the cut paper is guided in a state in which the left side of the cut paper abuts partially the edge guide 141d, so that the frictional resistance lessens and a feed failure such as paper break or a paper jam can be prevented.

Further, as cut paper is transported with the cut paper sandwiched between the subroller 151 and the driven rollers thereof 152a, 152b, and 152c in order, the cut paper is gradually inverted like a letter U. Thus, the cut paper portion positioned just below the paper feed roller 142 floats and gradually approaches the broken-away part of the paper feed roller 142; at the same time, the cut paper portion abutting the edge guide 141d also floats. Since the edge guide 141d is formed roughly like a triangular plate as shown in FIG. 7, the length of the cut paper portion abutting the edge guide 141d gradually shortens as the portion floats.

Therefore, as the cut paper is transported with the cut paper sandwiched between the subroller 151 and the driven rollers thereof 152a, 152b, and 152c in order, the frictional resistance of the cut paper portion abutting the edge guide 141d gradually lessens, so that the feeding accuracy can be maintained high and the record accuracy can also be maintained high. The shape of the edge guide 141d is not limited to the roughly triangular form and if it is a shape to allow the length of the portion abutting the edge guide 141d to gradually shorten when the cut paper floats, such as a rough sector form or a roughly trapezoidal form, a similar advantage is provided.

One paper feed roller 142 and one separation member 143 are disposed integrally with the right edge guide 141b and one paper feed roller 142 and one separation member 143 are disposed integrally with the left edge guide 141c. That is, each paper feed roller 142 is pierced through with both sides of a paper feed roller shaft 146 journaled at both ends by side frames 107 for rotation and is placed on a frame 141ba, 141ca extended from the edge guide 141b, 141c. Each separation member 143 is placed below each paper feed roller 142 and is attached to the depth of the edge guide 141b, 141c.

The paper feed roller 142 and the separation member 143 disposed in the right edge guide 141b are fixedly attached to the right side of the support plane 141a, and the paper feed roller 142 and the separation member 143 disposed in the left edge guide 141c are attached slidably from the left side of the support plane 141a to the right side. A paper feed roller in a related art is disposed so as to feed only one side of cut paper and has a width formed comparatively small, but the paper feed roller 142 is disposed so as to feed both sides of cut paper and has a width formed comparatively wide. Accordingly, the whole press pressure can be increased while the contact pressure per unit area imposed on the paper face from the paper feed roller 142 at the paper feeding time is decreased, so that comparatively wide cut paper, for example, paper of A2 size in the JIS can be fed straightly and particularly damage to print-dedicated paper caused by the paper feed roller 142 can be suppressed.

Two auxiliary rollers 147 are disposed with a predetermined spacing between the two paper feed rollers 142. Compression springs 148 which are the same at least on both sides are inserted into three spaces between the rollers 142 and 147. Since the auxiliary rollers 147 can press the intermediate portion of fed cut paper, deflection of comparatively wide cut paper, for example, paper of A2 size in the JIS in the width direction can be prevented and the paper can be fed straightly.

Since the compression springs 148 axially urge the rollers 142 and 147, if the left edge guide 141c is slid on the support plane 141a for moving the left paper feed roller 142, the auxiliary rollers 147 also move accordingly while linearly changing the spaces between the rollers 142 and 147. Therefore, the intermediate portion of paper of various sizes can be pressed reliably and deflection can be prevented.

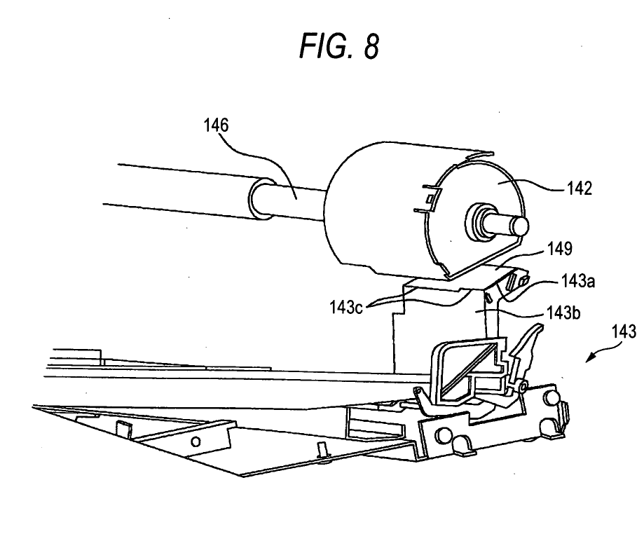

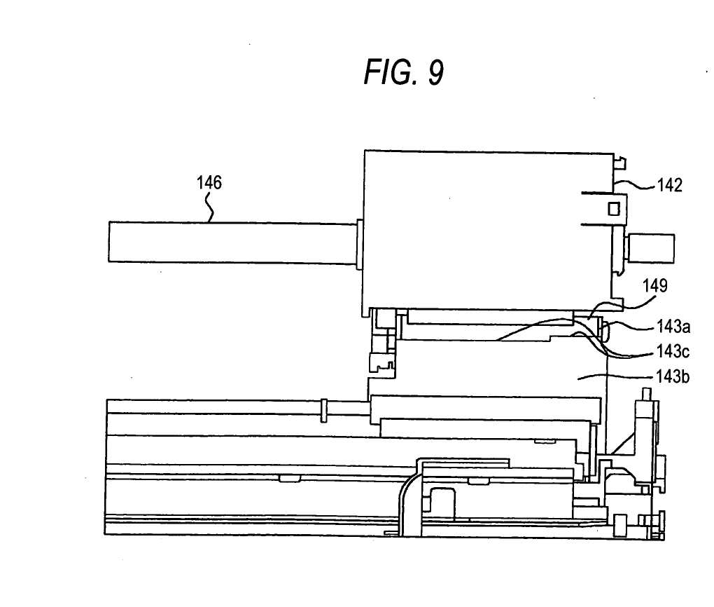

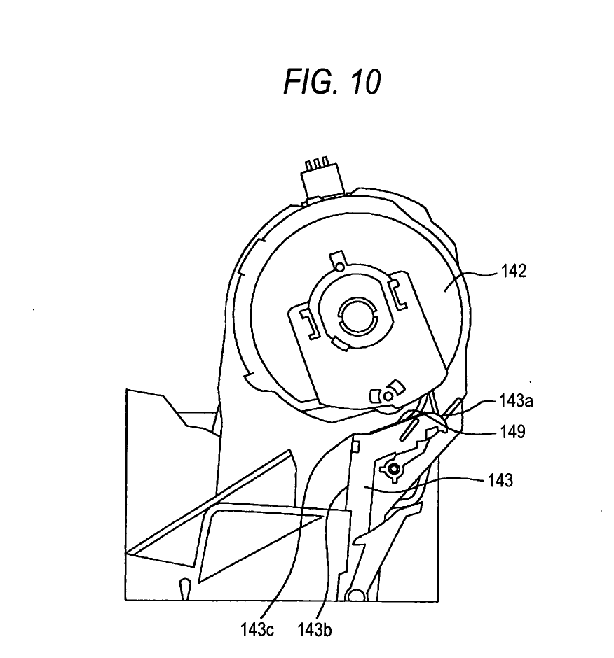

FIGS. 8 to 10 are a perspective view, a front view, and a side view to show details of the paper feed roller 142 and the separation member 143. A top face 143a of the separation member 143 is formed as a slope on which a separation pad 149 is put. A separation wall 143c is formed in the boundary between the top face 143a and a front 143b of the separation member 143. When cut paper drawn out by the paper feed roller 142 is fed multiply, the top sheet of paper is separated by the separation wall 143c or the separation pad 149 in response to the type of paper, namely, the thickness.

The separation wall 143c is formed so that as the right separation pad 149, the height of the summit on the right end side is a little higher than the height of the summit on the center side and that as the left separation pad 149, the height of the summit on the left end side is a little higher than the height of the summit on the center side. The reason why such a form is adopted is as follows: At the beginning, the minimum gap between the summit of the separation wall 143c and the peripheral surface of the paper feed roller 142 was set so as to become a distance for preventing a large number of sheets of so-called ordinary paper, namely, thin cut paper from entering the gap.

However, a problem of a large number of sheets of pliant cut paper, namely, thick cut paper entering the above-mentioned gap was found and thus the gap was set narrower (about 1 mm). Accordingly, a large number of sheets of thick cut paper were able to be prevented from entering the gap, but a problem occurred in thin cut paper. That is, since thin cut paper is easy to break, often both sides bend upward and thus although the center of thin cut paper was able to enter the above-mentioned gap, both sides may be unable to enter the gap because of obstruction of the paper feed roller 142. In this case, only the center of the cut paper was pulled and thus an accident of bending or cutting both sides occurred.

Then, the separation wall 143c is formed so that the height of the summit on the right end side of the separation wall 143c of the right separation pad 147 the height of the summit on the left end side of the separation wall 143c of the left separation pad 147 are a little higher than the height of the summit on the center side, whereby the right end side and the left end side of the separation wall 143c block a large number of sheets of thick cut paper entering the gap and thin cut paper can smoothly enter the gap if both sides bend upward.

In the embodiment, the case where the edge guide 141d of the characteristic portion of the invention is applied to the ink jet printer 100 of front automatic paper feed type including the separation member 143 having the rough surface, namely, the separation member 143 with the separation pad 149 put on the top face 143a has been described, but the invention is not limited to it. For example, likewise the edge guide 141d can be applied to the front side and the rear side of an ink jet printer including a separation member having a roller and enabling front automatic paper feed and rear automatic paper feed or can be applied to an ink jet printer of front automatic paper feed type using a paper feed cassette including separation members having claws, and a description is given below with reference to drawings:

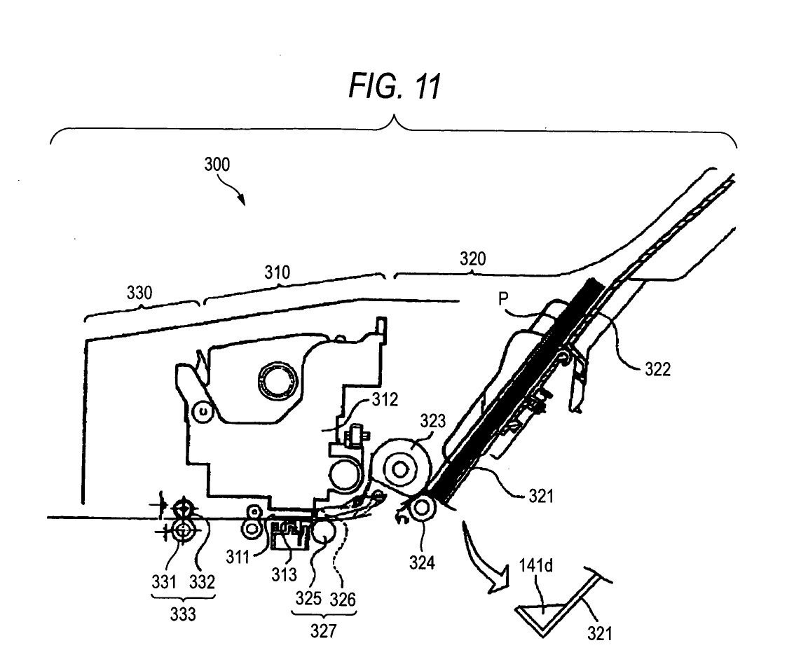

FIG. 11 is a sectional view to show the internal structure of an ink jet printer including a separation member having a roller and enabling front automatic paper feed and rear automatic paper feed. In the ink jet printer 300, a paper feed section 320 is disposed on the rear top of a printer main unit 310 and a paper ejection section 330 is disposed forward of the printer main unit 310. A paper feed tray 321 on which a plurality of sheets of paper P can be stacked is disposed in the paper feed section 320. A paper support 322 for supporting a plurality of sheets of paper P is detachably disposed in the paper feed tray 321. The above-described edge guide 141d is formed on the lower side wall of the paper feed tray 321. A paper feed roller 323 and a retard roller 324 opposed to the paper feed roller 323 are disposed below the paper feed tray 321.

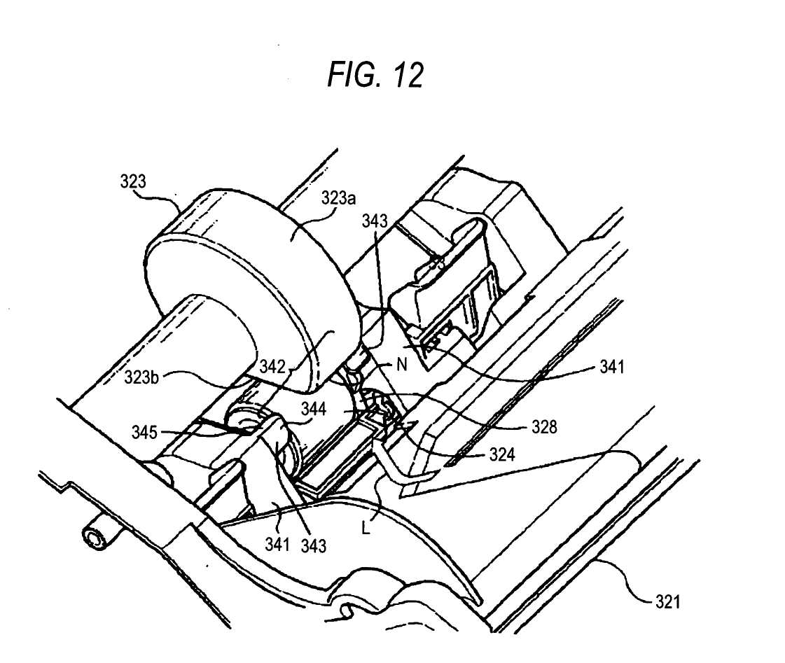

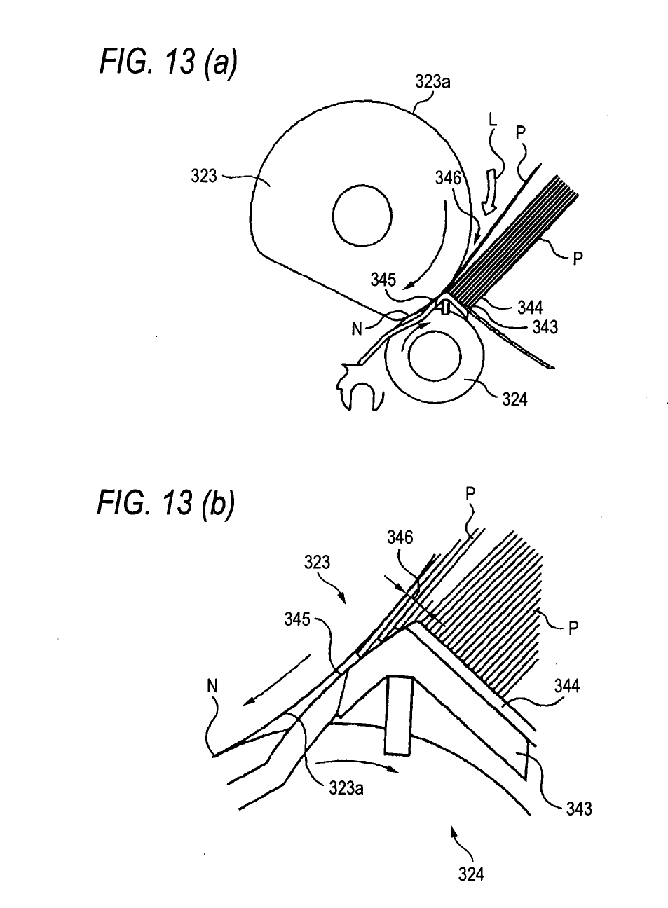

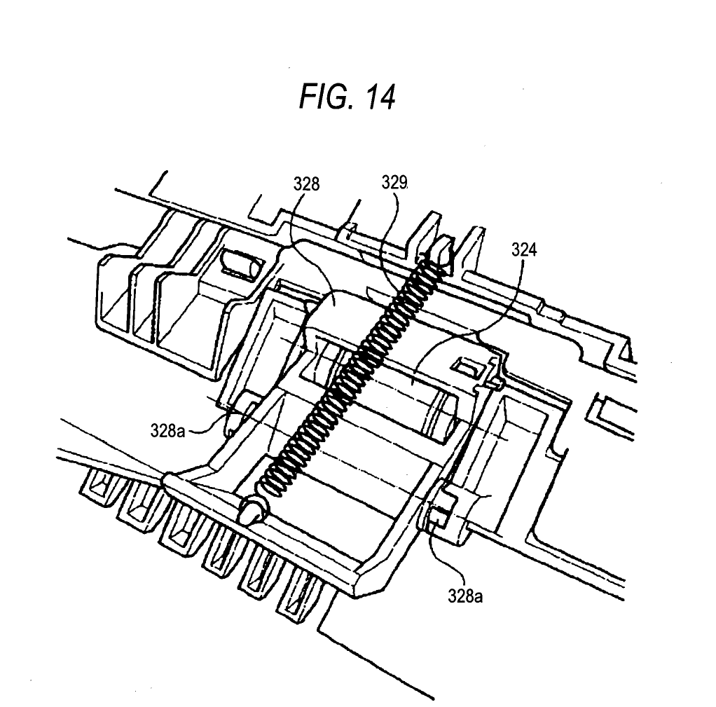

FIG. 12 is a perspective view to show the periphery of the retard roller 324, FIG. 13 is a side view of FIG. 12, and FIG. 14 is a rear perspective view of FIG. 12. As shown in FIGS. 12 and 13, the paper feed roller 323 is a roller of side view D type in cross section and includes an outer peripheral surface 323a capable of forming a sandwichable portion, namely, a nip point N in cooperation with the outer peripheral surface of the retard roller 324 and a flat portion 323b broken away like a flat and forming no nip point between the portion and the outer peripheral surface of the retard roller 324.

As shown in FIGS. 12 and 13, the retard roller 324 is a cylindrical roller having a horizontal rotation shaft and is supported on a retard roller support frame 328 for rotation and is always urged to the side of the paper feed roller 323 as the retard roller support frame 328 receives the urging force rotating in the surrounding of a support shaft 328a by the action of a coil spring 329, as shown in FIG. 14. When only one sheet of paper P is fed, the retard roller 324 rotates as it is driven by the paper feed roller 323; when two or more sheets of paper P are multiply fed, the retard roller 324 rotates in the same direction as the paper feed roller 323 for returning the sheet of paper P below the top sheet of paper P upstream in the paper feed direction.

As shown in FIG. 12, the retard roller 324 is formed on both sides with two upright portions 341 formed from a frame for supporting the paper feed roller 323, and paper P passes through a paper guide passage L formed so as to pass through the portion just above the upright portions 341 from the side of the paper feed tray 321 and is supplied to the side of the paper feed roller 323. A bay portion 342 for paper P to enter the space between both the rollers 323 and 324 is formed at a midpoint in the paper guide passage L and just before the nip point N between the paper feed roller 323 and the retard roller 324. Two bay regulation members 343 opposed and extended toward the bay portion 342 from both sides are formed from the upper end parts of the two upright portions 341 and each bay regulation member 343 includes an abutment regulation section 344 for regulating the number of sheets of paper P guided into the bay portion 342 and a paper guide face 345 extended from the upper end of the abutment regulation section 344 to the side of the nip point N.

As shown in FIG. 13, the abutment regulation section 344 is formed almost perpendicularly to the direction in which paper is transported along the paper guide passage L, and a gap 346 for allowing several sheets of paper P to pass through is formed between the upper end of the abutment regulation section 344 and the outer peripheral surface 323a of the paper feed roller 323. According to the configuration, if a plurality of sheets of paper P are transported, the sheet of paper P positioned below the several sheets of paper P that can pass through the gap 346 abuts the abutment regulation section 344 at the leading end and therefore is prevented from further proceeding. Consequently, the number of sheets of paper P supplied to the space between the paper feed roller 323 and the retard roller 324 can be limited.

As shown in FIG. 13, the paper guide face 345 is formed so as to make a convex curved surface on the upper side and as it goes forward, the distance between the outer peripheral surface 323a of the paper feed roller 323 and the paper guide face 345 becomes narrower. Accordingly, the leading end parts of the sheets of paper P multiply transported can be shifted by the action of the convex curved surface before paper separation by the action of the paper feed roller 323 and the retard roller 324, so that a preparatory separation function of paper separation in the retard roller 324 can be provided.

As the paper guide face 345 is formed, the leading ends of several sheets of paper P passing through the gap 346 can be prevented from deflecting downward just after passing through the gap 346, coming in contact with the outer peripheral surface of the retard roller 324, and being bent. Therefore, the paper guide face 345 is formed extending in the paper transport direction by sufficient length so as to prevent the leading end of paper P from entering such an unfavorable state.

In such a configuration, paper P in the paper feed tray 321 is taken out as the outer peripheral surface of the paper feed roller 323 provided below the paper feed tray 321 comes in frictional contact. When multiple sheets of paper P taken out are fed, only the top sheet of paper P is separated and is delivered in cooperation with the retard roller 324 opposed to the paper feed roller 323. The delivered sheet of paper P arrives at a paper delivery roller 327 made up of a paper delivery drive roller 325 and a paper delivery driven roller 326 opposed thereto on the upper side, and is fed into a platen 311 positioned downstream from the paper feed roller 327 while undergoing accurate paper feed operation in a record execution process by a drive system. While the fed paper P smoothly passes through the top of the platen 311, high-quality recording is performed by a record head unit 313 placed on a carriage 312.

When the paper P is fed as described above, the paper portion positioned just below the paper feed roller 323 floats and gradually approaches the flat portion 323b of the paper feed roller 323; at the same time, the paper portion abutting the edge guide 141d also floats. Since the edge guide 141d is formed roughly like a triangular plate, the length of the paper portion abutting the edge guide 141d gradually shortens as the portion floats. Therefore, as the paper is fed, the frictional resistance of the paper portion abutting the edge guide 141d gradually lessens, so that the feeding accuracy can be maintained high and the record accuracy can also be maintained high. The recorded paper P is drawn out and is ejected by a paper ejection roller 333 made up of a paper ejection drive roller 331 and a paper ejection tooth roller 332 opposed thereto on the upper side.

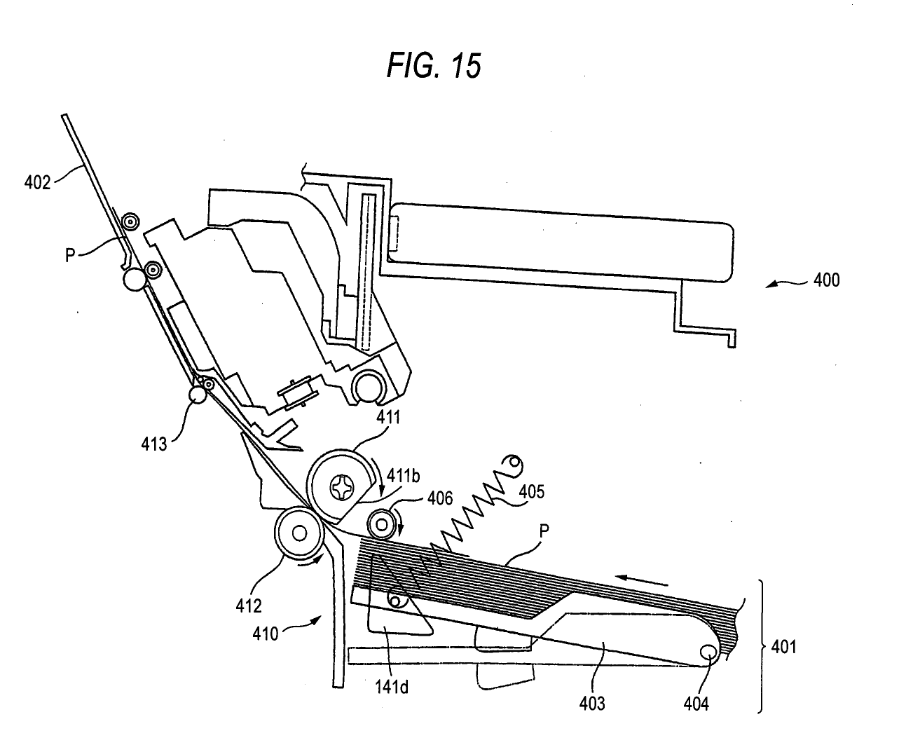

FIG. 15 is a sectional view to show the internal structure of an ink jet printer including a separation member having a roller and enabling front automatic paper feed. In the ink jet printer 400, a paper feed cassette 401 in which a large number of sheets of paper P can be stacked is disposed detachably on the lower front of a printer main unit 410, and a paper ejection stacker 402 to which post-recorded paper P is ejected is disposed above the rear of the printer main unit 410. In the paper feed cassette 401, a hopper 403 for lifting paper P stacked in the paper feed cassette 401 and guiding paper P into a feed passage is rockably disposed with a rocking shaft 404 as a rocking support point. The above-described edge guide 141d is formed on a side wall of the printer main unit 410 on the margin side of the leading end of the paper P lifted by the hopper 403.

In such a configuration, the hopper 403 rocked upward by the urging force of a push-up spring 405 presses the top sheet of paper P stacked against a pickup roller 406 disposed above the depth of the paper feed cassette 401. The top sheet of paper P is drawn out from within the paper feed cassette 401 by rotation of the pickup roller 406, and is delivered in the paper transport direction to a paper feed roller 411 and a retard roller 412 disposed in the printer main unit 410. A high friction material is put on the part of the hopper 403 positioned just below the pickup roller 406 for preventing the sheets of paper P stacked below the top sheet from moving.

Here, the rotation drive force from a drive motor not shown is transferred to the paper feed roller 411, which then is driven in the paper feed rotation direction. On the other hand, the retard roller 412 is journaled so that it can be driven for rotation in a state in which it has given rotation resistance, and is given press tendency against the paper feed roller 411 upon reception of the urging force from urging means. The rotation resistance of the retard roller 412 is set so as to become smaller than the frictional resistance of the peripheral surface of the paper feed roller 411 and larger than the frictional resistance between sheets of paper P multiply fed.

Therefore, if only one sheet of paper P is supplied to the space between the paper feed roller 411 and the retard roller 412, the retard roller 412 receives the press force and the rotation force from the paper feed roller 411 and is driven for rotation in the paper feed rotation direction and the sheet of paper P sandwiched between the paper feed roller 411 and the retard roller 412 is fed to a paper delivery roller 413. On the other hand, if a plurality of sheets of paper P are multiply fed into the space between the paper feed roller 411 and the retard roller 412, the retard roller 412 does not rotate and thus only the top sheet of paper P is fed with the rotation of the paper feed roller 411 and the sheets of paper P below the top sheet remain at the position. A return lever not shown starts the return operation and returns the remaining sheets of paper P to the inside of the paper feed cassette 401.

When the paper P is fed as described above, the paper portion positioned just below the paper feed roller 411 floats and gradually approaches a flat portion 411b of the paper feed roller 411; at the same time, the paper portion abutting the edge guide 141d also floats. Since the edge guide 141d is formed roughly like a triangular plate, the length of the paper portion abutting the edge guide 141d gradually shortens as the portion floats. Therefore, as the paper is fed, the frictional resistance of the paper portion abutting the edge guide 141d gradually lessens, so that the feeding accuracy can be maintained high and the record accuracy can also be maintained high. Recording and paper ejection are performed as with the ink jet printers 100 and 300 described above.

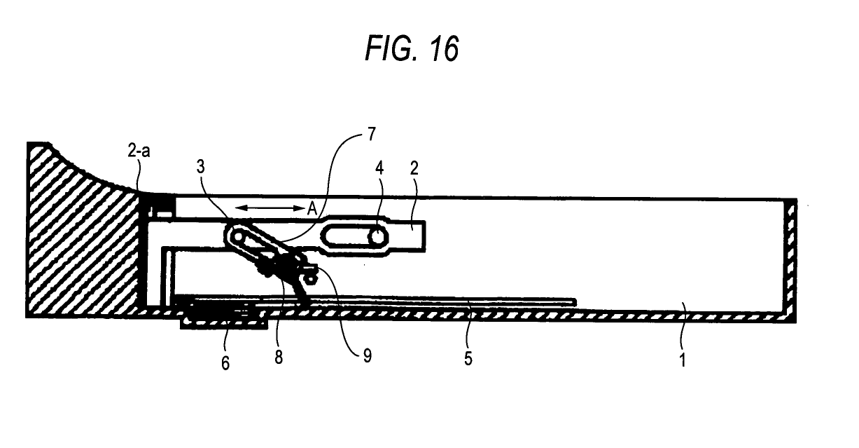

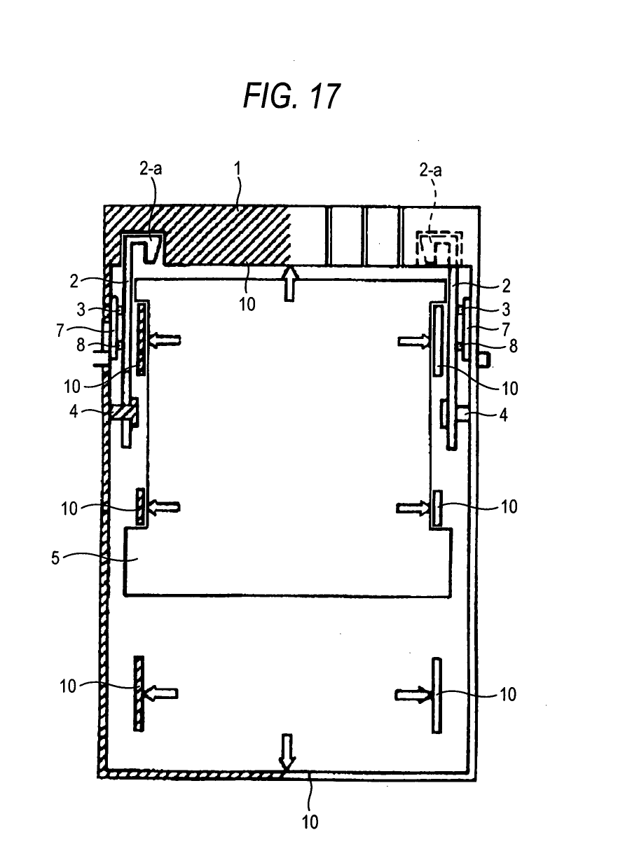

FIG. 16 is a sectional side view to show a paper feed cassette including separation members having claws. FIG. 17 is a plan view of the paper feed cassette. In the paper feed cassette 1, a pair of separation claw plates 2 is disposed in the width direction of paper so as to move in an arrow A direction by separation claw fulcrum shafts 4 each integrated with the inside of a side plate of the paper feed cassette 1. Each separation claw drive plate 7 is placed rotatably on a separation claw drive plate fulcrum shaft 8 formed inside the side plate of the paper feed cassette 1. The separation claw drive plate 7 is coupled with the separation claw plate 2 through a separation claw guide pin 3 integrated with the separation claw plate 2. When the separation claw drive plate 7 rotates on the separation claw drive plate fulcrum shaft 8, the separation claw plate 2 moves in the arrow A direction.

When the paper feed cassette 1 is not placed in an ink jet printer, the separation claw drive plate 7 is set at the position in FIG. 16 by a helical torsion coil spring 9. Therefore, the separation claw plate 2 moves in the front direction of the paper feed cassette 1 and a separation claw 2-a is stored on the front of the paper feed cassette 1. When the paper feed cassette 1 is not placed in an ink jet printer, a paper feed push-up plate 5 compresses a paper feed push-up spring 6 and is set at the position in FIG. 16.

In this state, the separation claw parts 2-a of the pair of left and right separation claw plates 2 are stored in the front of the paper feed cassette 1, as shown in FIG. 17. At this time, members hindering insertion when the user inserts paper do not exist in the paper set position defined by paper guide members 10. Therefore, it is made possible to insert paper from every direction without limiting to insertion of paper from the rear of the paper feed cassette 1 as in related arts and insertion of paper is also smoothed, so that if the user replenishes the paper feed cassette 1 with paper with ease, the paper is set reliably. At the replenishing time, the paper leading end does not interfere with the separation claw part 2-a and deformation of paper also becomes small; not only transportability can be improved, but also the quality of post-recorded paper can be greatly improved.

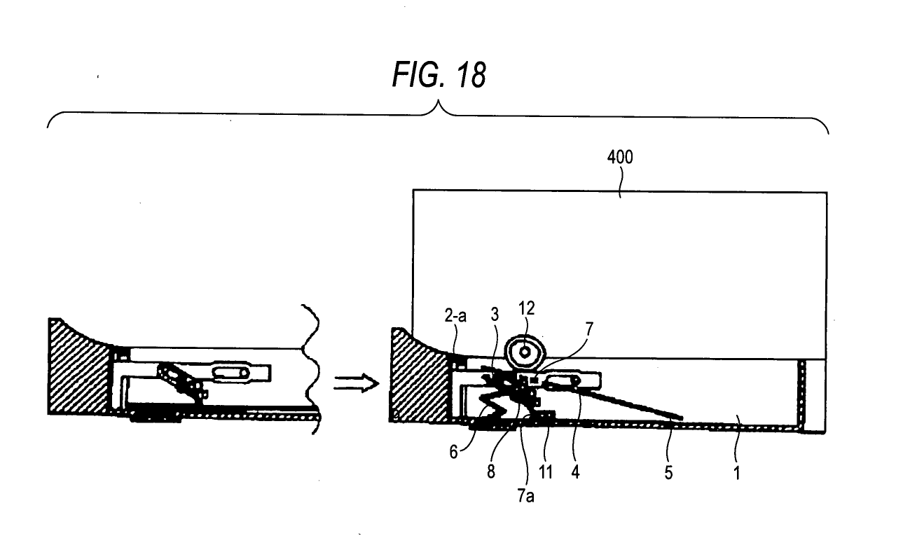

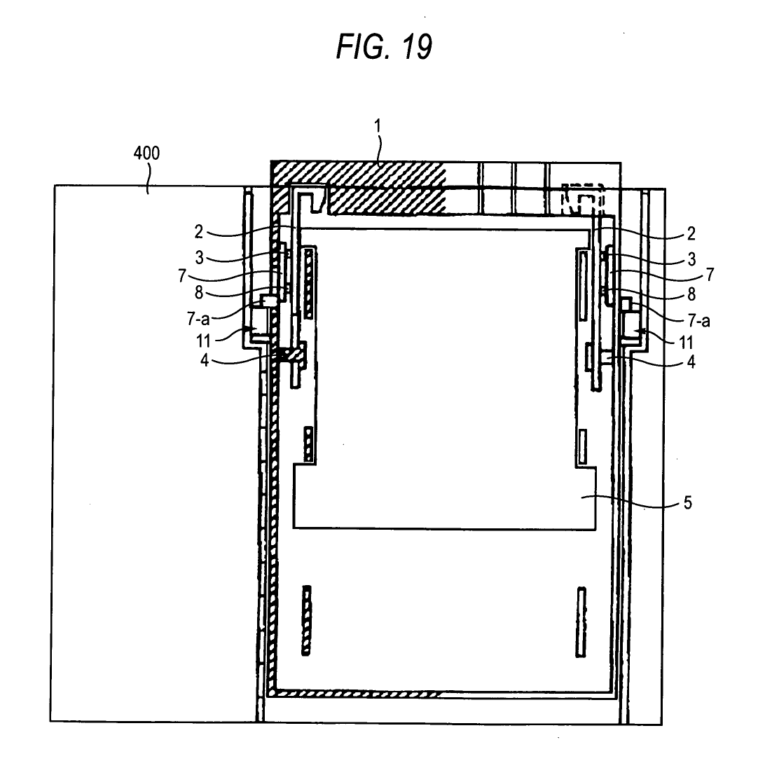

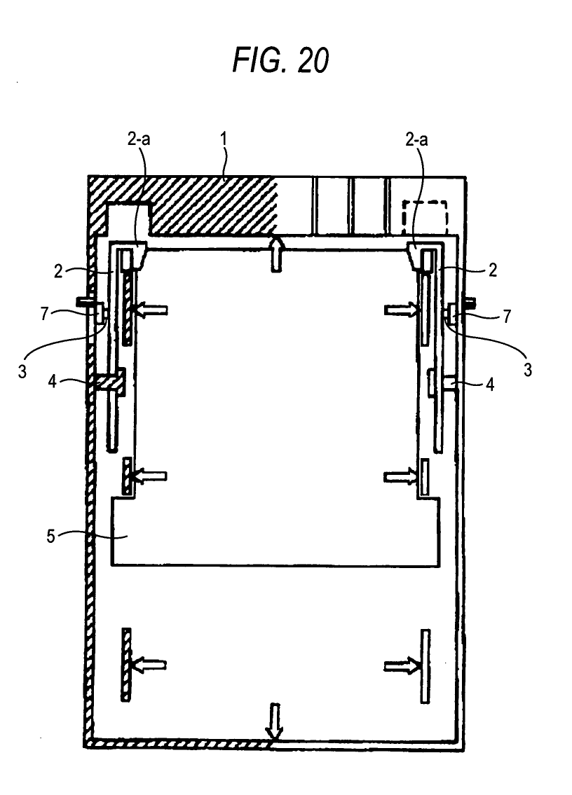

FIG. 18 is an operation drawing of a separation mechanism when the paper feed cassette 1 is placed in an ink jet printer, FIG. 19 is a plan view, and FIG. 20 is a plan view of the paper feed cassette 1 placed in the ink jet printer. When the paper feed cassette 1 is placed in the ink jet printer 400 in the arrow direction shown in FIG. 18, first a main unit coupling section 7-a of the separation claw drive plate 7 abuts a separation claw set lever 11 installed in a paper feed cassette placement opening of the ink jet printer 400. At this time, the paper feed push-up plate 5 is set in the position in the figure and abuts at a given pressure by a paper feed roller 12 and the paper feed push-up spring 6.

In this state, the pair of left and right separation claw drive plates 7 abuts the separation claw set levers 11 through the main unit coupling sections 7-a. If the user further pushes the paper feed cassette 1 forcibly into the ink jet printer 400 from this state, the separation claw set levers 11 rotate the separation claw drive plates 7 against the force of the helical torsion coil springs 9 and thus the separation claw plates 2 are also slid to the rear in the paper feed cassette 1 and are set. In this state, as shown in FIG. 20, the separation claw plates 2 moves to the rear from the state in which they are stored in the front part of the paper feed cassette 1 and the separation claws 2-a thereof enter the paper set position indicated by the arrows in the figure and are set in a state in which both sides of the paper leading end are pressed. Thus, the separation claw plates 2 are set at the appropriate positions for transporting paper separately one sheet at a time, so that it is made possible to reliably feed paper without multiple feeding.

The operation for printing on cut paper in the ink jet printer 100 in such a configuration will be discussed. As sheets of cut paper P stacked in the paper feed tray 210 of the paper feed and ejection tray 200 placed in the paper feed and ejection section 140, a paper bundle is pressed against the paper feed roller 142 as the hopper 141 moves up because of restoration of the compression spring 144 mechanically synchronized with rotation of the paper feed roller 142, and only the top sheet of cut paper P is separated by the separation member 143 and is fed into the transport section 150.

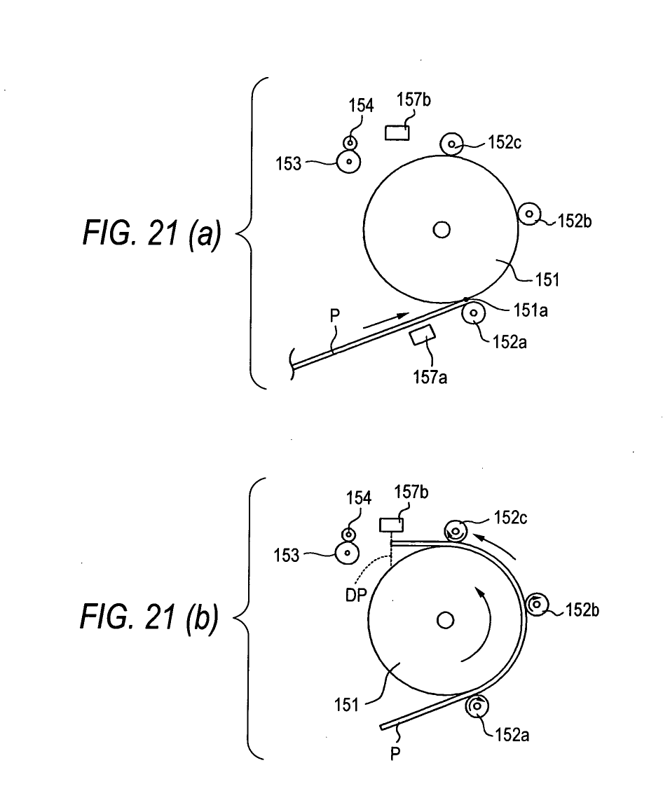

When fed cut paper P arrives at the contact point 151a between the subroller 151 and the driven roller 152a thereof as shown in FIG. 21 (A), skew removal of the cut paper P is performed. As the skew removal method, a different method is adopted depending on the paper thickness. That is, for cut paper as thin as or thinner than ordinary paper, the following method is adopted: The leading end of the cut paper is engaged only a little in the space between the subroller 151 and the driven roller 152a thereof and then the rollers 151 and 152a are reversely rotated for slackening the cut paper, thereby making even the leading end of the cut paper for skew removal.

On the other hand, for cut paper thicker than ordinary paper, the following method is adopted: The leading end of the cut paper is abutted against the contact point 151a between the subroller 151 and the driven roller 152a thereof and the paper feed roller 142 is slipped for making even the leading end of the cut paper for skew removal. The engagement amount and the abutment amount are detected by the detection sensor 157a and the skew removal is controlled according to the detected amount.

The reason why the different method is thus adopted depending on the paper thickness is that thin cut paper is not firm and thus it is feared that the paper feed roller 142 may deliver the cut paper without slipping on the cut paper and that thick cut paper is provided by pasting thin sheets of cut paper together and thus it is feared that peeling off may occur when the rollers 151 and 152a are reversely rotated.

The cut paper P whose skew removal is complete is sandwiched between the subroller 151 driven by a paper delivery motor not shown and the driven rollers thereof 152a, 152b, and 152c and is reversed on a U letter passage, namely, is transported in the opposite direction to the paper feed direction. When the leading end of the cut paper P arrives at a detection position DP of the detection sensor 157b as shown in FIG. 21 (B), locating the top, the print start position of the cut paper P is performed.

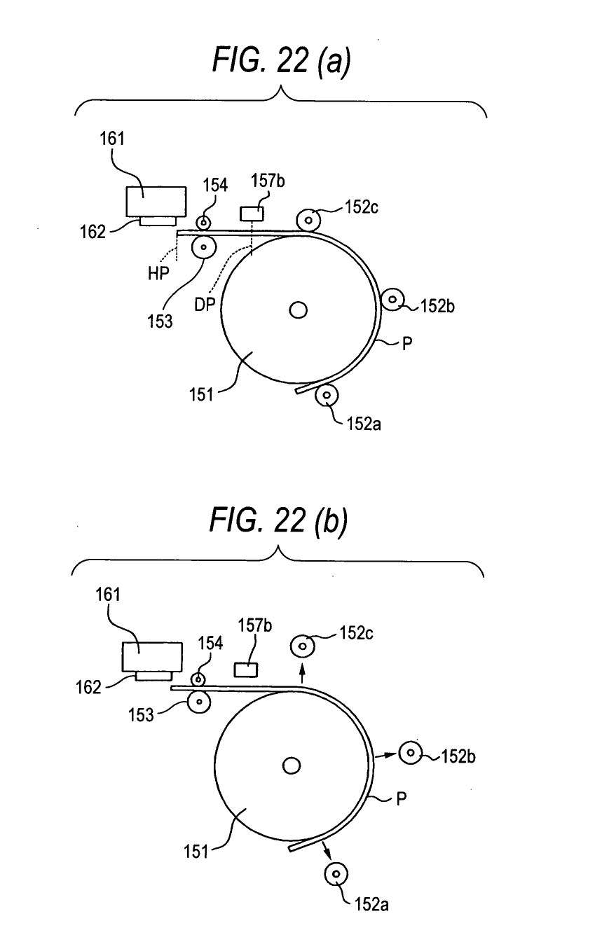

That is, the transport amount is detected by the detection sensor 157b until the leading end of the cut paper P passes through the space between the paper delivery roller 153 and the driven roller thereof 154 from the detection position DP and arrives at a top locating position HP shown in FIG. 22 (A), and locating the top is controlled according to the detected amount. Locating the top in related arts is preformed by the detection sensor 157a disposed upstream from the subroller 151. However, locating the top is preformed by the detection sensor 157b disposed downstream from the subroller 151, so that the detected amount may be small and particularly a top locating error caused by the paper thickness can be eliminated and the top locating accuracy can be enhanced.

Then, the cut paper P whose top locating is complete is transported to the record section 160 with the cut paper sandwiched between the paper delivery roller 153 driven by a paper delivery motor not shown and the driven roller thereof 154. Therefore, sandwiching the cut paper P between the subroller 151 and the driven rollers thereof 152a, 152b, and 152c causes the transport accuracy to worsen and thus the driven rollers 152a, 152b, and 152c are released from the subroller 151 as shown in FIG. 22 (B).

The transported cut paper P is attracted onto the platen 163 by a suction pump not shown and is made flat and is printed by the record head unit 162 mounted on the carriage 161 scanned by a carriage motor and a timing belt not shown. At this time, a control section of the ink jet recording apparatus 100 supplies each color ink from the ink cartridges of seven colors of yellow, light yellow, magenta, light magenta, cyan, light cyan, and black, for example, to the record head unit 162 and controls the ejection timing of each color ink and driving the carriage 161 and the paper delivery roller 153 for executing highly accurate ink dot control, halftone processing, etc. The cut paper P whose printing is complete is ejected to the paper feed and ejection section 140 with the cut paper P sandwiched between the paper ejection roller 155 driven by a paper delivery motor not shown and the serrated roller 156 and is stacked on the paper ejection tray 230 of the paper feed and ejection tray 200.

As described above, the edge guide 141d for guiding while partially abutting the left side of cut paper when the cut paper is fed is disposed in the paper feed and ejection section 140 of the embodiment. Therefore, the frictional resistance occurring between the left side of the cut paper and the edge guide 141d can be lessened, so that a paper feed failure such as paper break or a paper jam can be prevented from occurring. The edge guide 141d is formed integrally as a step projecting to the paper side with the left edge guide 141c attached slidably in the direction orthogonal to the paper feed direction and thus need not be provided as a separate part and the costs of parts manufacturing, assembling, etc., can be reduced. The edge guide 141d may be formed on the right edge guide 141b on the fix side or may be formed on both edge guides 141b and 141c.

The invention can also be applied to a facsimile machine, a copier, etc., if it is a recording apparatus including a medium transport apparatus. Not limited to the recording apparatus, as the meaning of liquid ejection apparatus for ejecting a liquid fitted for the purpose instead of ink onto a liquid-ejected medium from a liquid ejection head for depositing the liquid on the liquid-ejected medium, the invention can also be applied to apparatus including a color material ejection head used for color filter manufacturing of a liquid crystal display, etc., an electrode material (conductive paste) ejection head used for electrode formation of an organic EL display, a face light emission display (FED), etc., a biological organic substance ejection head used for biochip manufacturing, a specimen ejection head as an accurate pipette, or the like.

1. A feeder for feeding a medium, characterized by:
a guide section for guiding the medium while partially abutting one side of the medium in feeding the medium.

2. The feeder as claimed in claim 1, characterized in that said guide section is formed as a step in guide means attached slidably in a direction orthogonal to the feeding direction of the medium.

3. The feeder as claimed in claim 1 or 2, characterized in that said feeder comprises supply means for supplying the stored media, separation means for separating only the top medium of the supplied media, and feeding means for feeding the separated medium and that said guide section is formed so that feed load occurring as the medium and said guide section come in contact with each other lessens when the medium is displaced in a gap between the separation means and the supply means with the progress of feeding of the feeding means after supply of the supply means is released.

4. The feeder as claimed in claim 3, characterized in that said guide section is formed so that the abutment portion against the medium gradually decreases with the progress of feeding the medium by the feeding means.

5. The feeder as claimed in claim 3 or 4, characterized in that the separation means includes a rough surface for separating only the top medium.

6. The feeder as claimed in claim 3 or 4, characterized in that the separation means includes a roller for separating only the top medium.

7. The feeder as claimed in claim 3 or 4, characterized in that the separation means includes a claw for separating only the top medium.

8. A recording apparatus characterized in that it comprises a feeder as claimed in any one of claims 1 to 7.

9. A liquid ejection apparatus characterized in that it comprises a feeder as claimed in any one of claims 1 to 7.
